(19) United States
(12) Patent Application Publication
(10) Pub. No.: US 2011/0164278 A1
(43) Pub. Date: Jul. 7, 2011

(54) IMAGE FORMING APPARATUS

(75) Inventor: Toshihiro Yamakawa, Osaka (JP)

(73) Assignee: SHARP KABUSHIKI KAISHA, Osaka (JP)

(21) Appl. No.: 12/984,384

(22) Filed: Jan. 4, 2011

(30) Foreign Application Priority Data
Jan. 5, 2010 (JP) 2010-000324

(51) Int. Cl. G06F 3/12

(52) U.S. Cl. 358/1.15

(57) ABSTRACT

This invention provides an image forming apparatus in which a user is able to select whether or not to execute shared printing. Message data is generated to inquire of a user whether it is allowed to print newly received print data at printing execution time specified by a printing execution time and date specifying portion, and a transmitting/receiving portion transmits the inquiry message to a PC. When an allowed/not-allowed signal is an allowed signal, a print processing control portion changes printing execution time and date of the newly received print data to the printing execution time and date specified by the printing execution time and date specifying portion, and when coming to the specified printing execution time and date, printing of the print data is executed.

### CROSS-NOTING PARAGRAPH

This non-provisional application claims priority under 35 U.S.C. §119(a) on Patent Application No. 2010-000324 filed in JAPAN on Jan. 5, 2010, the entire contents of which are hereby incorporated herein by reference.

### FIELD OF THE INVENTION

The present invention relates to an image forming apparatus, and particularly to an image forming apparatus which receives print data including printing execution time information transmitted from an external apparatus and prints the print data at the printing execution time indicated by the printing execution time information which is included in the print data.

### BACKGROUND OF THE INVENTION

Japanese Laid-Open Patent Publication No. 2008-209974 discloses an image forming apparatus which receives print data (also referred to as a print job) including printing execution time information (hereinafter simply referred to as printing execution time) transmitted from an external apparatus such as a PC and prints the print data at the printing execution time included in the print data in order to improve convenience for a user.

In addition, Japanese Laid-Open Patent Publication No. 2008-23891 discloses an image forming apparatus which receives and records a plurality of print data including printing execution time transmitted from an external apparatus such as a PC and performs batch printing of a plurality of print data including the same printing execution time at the same printing execution time in order to reduce power consumption due to a plurality of warm-ups and save energy. By using the image forming apparatus disclosed in Japanese Laid-Open Patent Publication No. 2008-23891, it is possible to reduce the number of warm-ups, and thereby, it possible to save energy.

By the way, it is assumed that when print data X including printing execution time T₁ is recorded in an image forming apparatus, a user X operates a PC to instruct the image forming apparatus to print a print data N. Then, the PC transmits the print data N to the image forming apparatus and the image forming apparatus receives and records the print data N.

In this case, when the image forming apparatus does not print the newly received print data N immediately but print at the recorded printing execution time T₁ which is included in the print data X, it is possible to perform batch printing (also referred to as shared printing) of the print data X and the print data N. As a result, it is possible to perform batch printing of the print data X and the print data N with one-time warm-up, and to reduce the number of warm-ups and save energy.

However, when the user X desires to print the print data N immediately or at printing execution time T₂, it is extremely inconvenient for the user X to execute such shared printing automatically.

On the other hand, when the user X allows for the shared printing, for example, in the case where it is not particularly inconvenient for the user X to print the print data N at the time when it is out of synchronization with the time desired by the user X, it is possible to save energy by executing the shared printing.

### SUMMARY OF THE INVENTION

An object of the present invention is to provide an image forming apparatus in which a user is able to select whether or not to execute shared printing.

Another object of the present invention is to provide an image forming apparatus which receives print data including printing execution time transmitted from an external apparatus and prints the print data at the printing execution time, comprising: a recording portion which records print data including printing execution time transmitted from an external apparatus; a message data generating portion which, when newly receiving print data including printing execution time transmitted from an external apparatus, generates message data to inquire of a user whether it is allowed to print the newly received print data at printing execution time included in the print data recorded in the printing portion; a message data transmitting portion which transmits the message data generated by the message data generating portion to the external apparatus; an allowed/not-allowed information receiving portion which receives allowed/not-allowed information transmitted from the external apparatus, the allowed/not-allowed information being related to user's answer to the massage data; and a print processing control portion which determines printing execution time of the newly received print data based on the allowed/not-allowed information from the user received by the allowed/not-allowed information receiving portion.

Another object of the present invention is to provide the image forming apparatus, comprising a printing execution time specifying portion that specifies, from the plurality of printing execution times, when a plurality of print data including printing execution time are recorded in the recording portion, at least one of the printing execution times whose time difference with a printing execution time included in the newly received print data is equal to or less than a predetermined value, and further specifies, from the at least one of the printing execution times, a printing execution time which is just prior to the printing execution time included in the newly received print data, and wherein the message data generating portion generates message data to inquire of a user whether it is allowed to print the newly received print data at the just-prior printing execution time specified by the printing execution time specifying portion.

Another object of the present invention is to provide the image forming apparatus, comprising a printing execution time specifying portion that specifies, from the plurality of printing execution times, when a plurality of print data including printing execution time are recorded in the recording portion, at least one of the printing execution times whose time difference with a printing execution time included in the newly received print data is equal to or less than a predetermined value, and further specifies, from the at least one of the printing execution times, a printing execution time which is nearest to the printing execution time included in the newly received print data, and wherein the message data generating portion generates message data to inquire of a user whether it is allowed to print the newly received print data at the nearest printing execution time specified by the printing execution time specifying portion.

Another object of the present invention is to provide the image forming apparatus, wherein, the message data generating portion, when one print data including printing execution time is recorded in the recording portion, only in a case where a time difference between the printing execution time included in the one print data and the printing execution time included in the newly received print data is equal to or less than a predetermined value, generates message data to inquire of a user whether it is allowed to print the newly received print data at the printing execution time included in the one print data.

Another object of the present invention is to provide the image forming apparatus, wherein, the message data generating portion, after printing of the newly received print data is completed, generates completion of printing message data indicating that printing of the print data is completed, and the message data transmitting portion transmits the completion of printing message data generated by the message data generating portion to the external apparatus.

Another object of the present invention is to provide the image forming apparatus, wherein, a setting portion which sets the predetermined value to be changeable is included.

Another object of the present invention is to provide the image forming apparatus, wherein, a warm-up operation is not executed even though print data transmitted from the external apparatus is newly received.

### BRIEF DESCRIPTION OF THE DRAWINGS

FIG. 1 is a diagram showing a state where an image forming apparatus according to the present invention and a PC are connected through a network;

FIG. 2 is a schematic cross-sectional view of the main part of the image forming apparatus according to the present invention;

FIG. 3 is a functional block diagram of the PC;

FIG. 4 is a diagram showing a printing condition setting window;

FIG. 5 is a functional block diagram of the image forming apparatus according to the present invention;

FIG. 6 is a diagram schematically showing a state where a plurality of print data are recorded in a print data recording portion;

FIG. 7 is a diagram showing an inquiry message;

FIG. 8 is a diagram showing a completion of printing message;

FIG. 9 is a first flowchart illustrating a flow of generation processing of message data and print processing of print data executed in the image forming apparatus;

FIG. 10 is a second flowchart illustrating the flow of generation processing of message data and print processing of print data executed in the image forming apparatus; and

FIG. 11 is diagram showing a predetermined value setting dialogue.

### PREFERRED EMBODIMENTS OF THE INVENTION

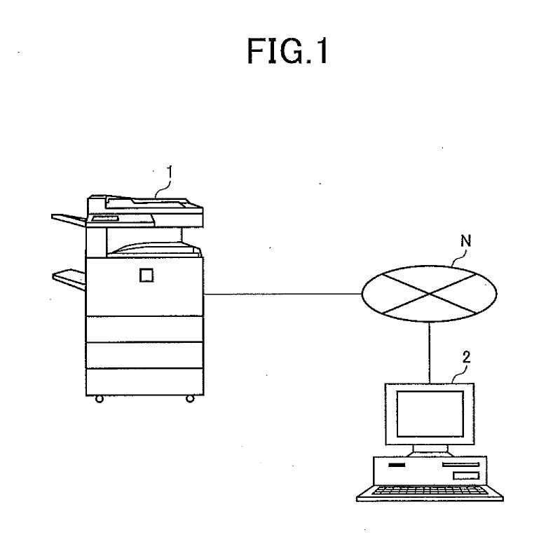

FIG. 1 is a diagram showing a state where an image forming apparatus 1 according to the present invention and an external apparatus (hereinafter referred to as a PC 2) which transmits print data to the image forming apparatus 1 and causes the image forming apparatus 1 to execute print processing are connected through a network N. Note that, the network N is comprised of a network such as an internet or a local network.

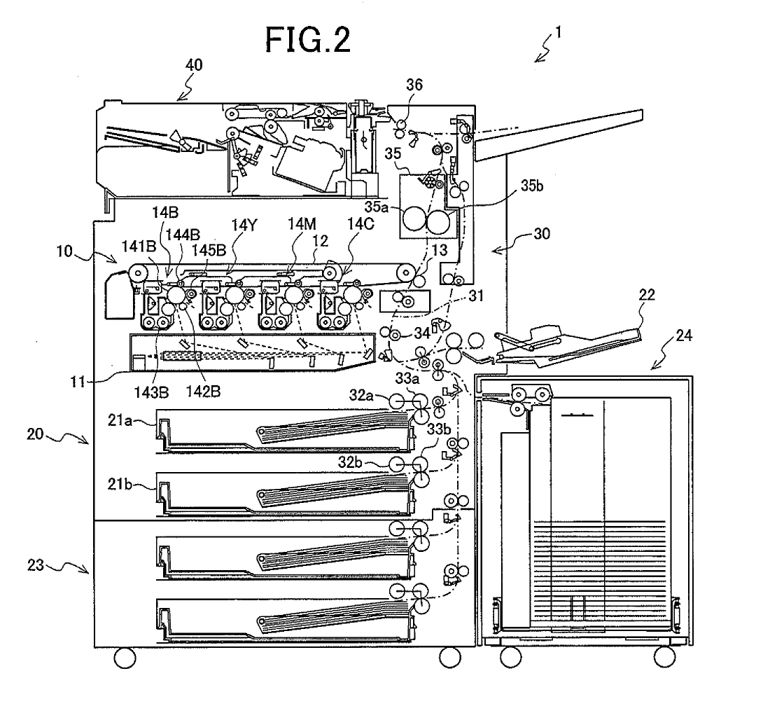

FIG. 2 is a schematic cross-sectional view illustrating a configuration of the image forming apparatus 1 according to the present invention.

The image forming apparatus 1 includes an image forming portion 10, a paper storage portion 20, a paper conveyance portion 30, and a post processing apparatus 40.

First, description will be given for the image forming portion 10. The image forming portion 10 is configured by including an exposure unit 11, an intermediate transfer belt 12, and a secondary transfer roller 13, and by arranging image forming stations 14C, 14M, 14Y, and 14B in a line between the intermediate transfer belt 12 and the exposure unit 11.

Each of the image forming stations 14C, 14M, 14Y, and 14B performs image formation based on image information of each color of four colors in total including cyan, magenta, and yellow which are three primary colors of subtractive mixture obtained by color separation of a color image, and black in addition.

The image forming station for black 14B includes a photoreceptor drum 141B, a charging roller 142B, a developing unit 143B, and a primary transfer roller 144B, a cleaning unit 145B and the like.

An image light based on the image information of black is irradiated from the exposure unit 11 to the photoreceptor drum 141B and an electrostatic latent image corresponding to the image information of the color of black is formed. Note that, a surface of the photoreceptor drum 141B is uniformly charged to a predetermined potential by the charging roller 142B.

The developing unit 143B supplies a black toner to the surface of the photoreceptor drum 141B on which the electrostatic latent image is formed and develops the electrostatic latent image as a toner image.

The toner image formed on the photoreceptor drum 141B is transferred to an outer circumferential surface of the intermediate transfer belt 12 which passes between the photoreceptor drum 141B and the primary transfer roller 144B. Note that, a toner which remains without being transferred is collected by the cleaning unit 145B.

A configuration of the image forming stations of each color of cyan, magenta, and yellow 14C, 14M, and 14Y is similar to the configuration of the image forming station 14B, therefore description thereof will be omitted.

The toner image transferred to the outer circumferential surface of the intermediate transfer belt 12 is conveyed to a position facing the secondary transfer roller 13 by rotation of the intermediate transfer belt 12. The secondary transfer roller 13 is pressed against the outer circumferential surface of the intermediate transfer belt 12 at a predetermined nip pressure.

Next, description of the paper storage portion 20 will be given. The paper storage portion 20 includes paper feed cassettes 21a and 21b, and a manual tray 22, each of which stores a plurality of sheets of paper of one kind. In addition, the image forming apparatus 1 optionally includes paper feed apparatuses 23 and 24 as external paper storage portions.

Next, description of the paper conveyance portion 30 will be given. In the paper conveyance portion 30, a paper conveyance path 31 is formed to lead from the paper feed cassettes 21a and 21b to the post processing apparatus 40 which is installed on an upper surface of the image forming apparatus 1, through the secondary transfer roller 13. On the paper conveyance path 31, pick-up rollers 32a and 32b, paper feed rollers 33a and 33b, a registration roller 34, a fixing unit 35, a discharge roller 36 and the like are arranged.

Paper which is picked up by the pick-up roller 32a and the like is conveyed on the paper conveyance path 31 to the registration roller 34. The registration roller 34 temporarily holds the paper which is conveyed on the paper conveyance path 31, and conveys the paper to the secondary transfer roller 13 at the right time when positioning an end of the toner image which is formed on the outer circumferential surface of the intermediate transfer belt 12 against an end of the paper.

When the timing control is performed by the registration roller 34, and the toner image formed on the outer circumferential surface of the intermediate transfer belt 12 is transferred to the paper, the paper to which the toner image is transferred is guided to the fixing unit 35.

The fixing unit 35 includes a heating roller 35a whose temperature is raised to a toner fusing temperature and a pressurizing roller 35b which is pressed against the heating roller 35a at a predetermined nip pressure. The paper is heated and pressurized in passing through the fixing unit 35 and discharged to the post-processing apparatus 40 by the discharge roller 36 in a state where the toner image is fixed on the surface thereof.

The post-processing apparatus 40 conveys the paper which has been discharged by the discharge roller 36 into the apparatus, and applies stapling processing, punch processing and the like to the paper to discharge to a discharge tray.

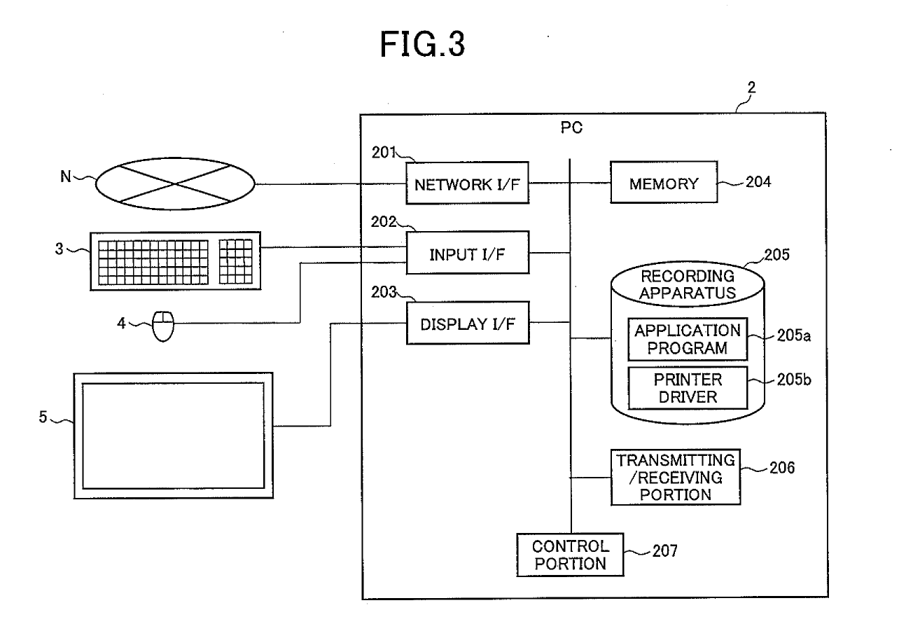

Description of a function of the PC 2 shown in FIG. 1 will hereinafter be given with reference to a functional block diagram of FIG. 3.

The PC 2 includes a network I/F 201, an input I/F 202, a display I/F 203, a memory 204, a recording apparatus 205, a transmitting/receiving portion 206, and a control portion 207.

The network I/F 201 provides an interface function for the network N and executes data transmission/reception to/from the image forming apparatus 1 which is connected to the network N.

The input I/F 202 provides an interface function for an input apparatus such as a keyboard 3 and a mouse 4. The display I/F 203 provides an interface function for a display apparatus such as a liquid crystal display 5.

The memory 204 is comprised of a ROM, a RAM and the like, and stores various control information and the like. The recording apparatus 205 is a large capacity storage apparatus such as a HDD (Hard Disk Drive) and records an application program 205a and a printer driver 205b together with an operating system. The application program 205a is an application of word-processing software, spreadsheet software, a browser and the like. The printer driver 205b generates print data including printing execution time and controls an operation of the image forming apparatus 1 at the time of print processing.

The transmitting/receiving portion 206 controls processing of transmitting the print data generated by the printer driver 205b to the image forming apparatus 1 through the network I/F 201, processing of receiving message data (described below) transmitted from the image forming apparatus 1, and the like.

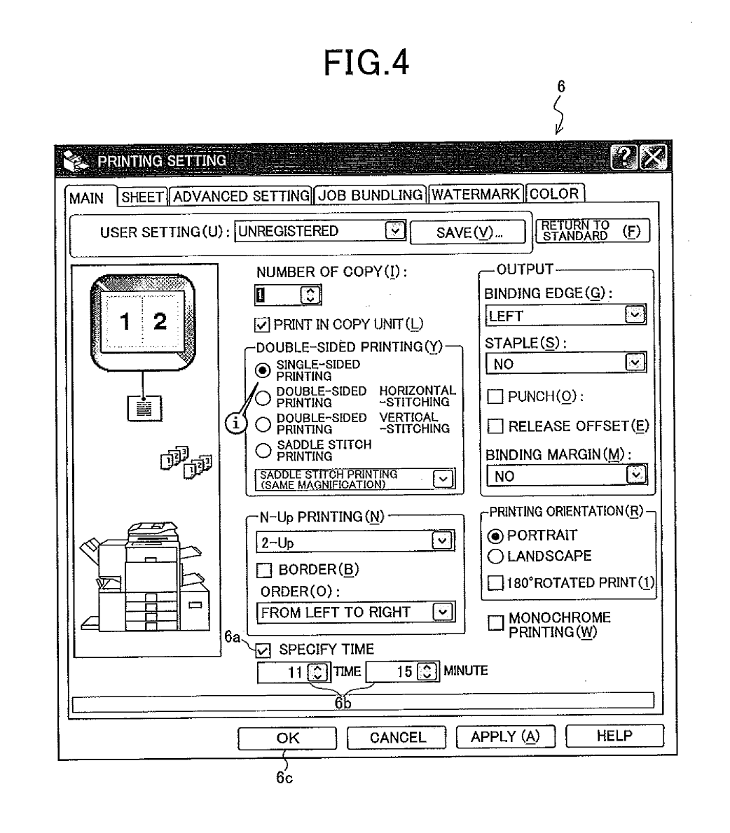

The control portion 207 is comprised of a CPU and the like and operates based on the operating system and the application program 205a which are recorded in the recording apparatus 205. When the user X requests print processing from the keyboard 3 or the mouse 4 while the application program 205a is running, the printer driver 205b is activated. Then the activated printer driver 205b displays, for example, a printing condition setting window 6 shown in FIG. 4 on the liquid crystal display 5.

The printing condition setting window 6 shown in FIG. 4 is a window for setting various printing conditions and has a check box for specifying time 6a which specifies printing execution time of the print data generated by the printer driver 205b. When the user X clicks the check box for specifying time 6a with use of the mouse 4 and the like, time input boxes 6b are displayed below the box 6a (enabling). Note that, at the time, it is assumed that current time is displayed in the time input boxes 6b.

When the user X inputs printing execution time, for example, 11:15 in the time input boxes 6b with use of the keyboard 3 and the mouse 4, and clicks an OK button 6c, the printer driver 205b generates print data related to the application program 205a which is running. For example, when the application program 205a which is running is a word-processing application, print data comprised of a page description language (PDL) and the like is generated based on document data generated by the word-processing application.

Then, the printing execution time (specifying time) which has been input in the time input boxes 6b of the printing condition setting window 6 by the user X is included in the print data. Note that, the printing execution time may be recorded in a header area and the like of the print data.

When the user X desires to print the print data immediately without specifying printing execution time of the print data, that is, when the user X does not click the check box for specifying time 6a with use of the mouse 4 and the like, for example, “0” or the time when the OK button 6c is clicked is set as printing execution time. Note that, “0” is also information related to printing execution time of the present invention.

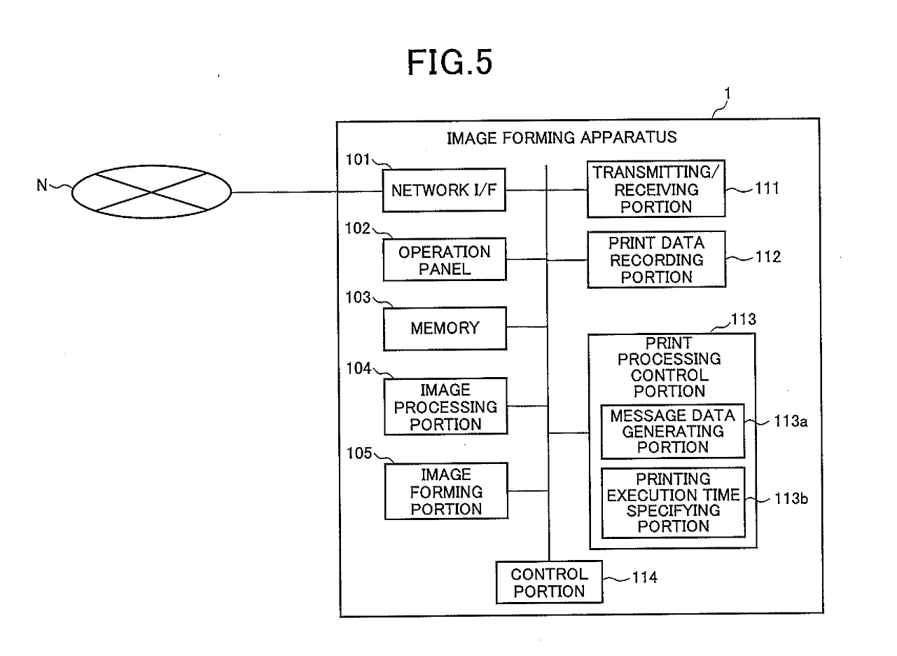

Next, description of a function of the image forming apparatus 1 shown in FIG. 1 will be given with reference to a functional block diagram of FIG. 5.

The image forming apparatus 1 includes a network I/F 101, an operation panel 102, a memory 103, an image processing portion 104, an image forming portion 105, a transmitting/receiving portion 111, a print data recording portion 112, a print processing control portion 113, and a control portion 114.

The network I/F 101 provides an interface function for the network N and executes data transmission/reception to/from the PC 2 and the like which is connected to the network N.

The operation panel 102 is comprised of a display panel which displays an operation screen of the image forming apparatus 1, various keys for operating the image forming apparatus 1, and the like.

The memory 103 is comprised of a ROM, a RAM and the like, and stores various control information and the like.

The image processing portion 104 converts print data (PDL data) recorded in the print data recording portion 112 to bit map data for printing to output to the image forming portion 105.

The image forming portion 105 includes the exposure unit 11, the intermediate transfer belt 12, the secondary transfer roller 13 (see FIG. 2) and the like, and executes image formation based on the bit map data which has been output by the image processing portion 104. Note that, usually, when an image forming apparatus newly receives print data, various warm-up operations are executed to execute heating processing of the heating roller 35a (see FIG. 2) of the fixing unit 35, and the like, however, the image forming portion 105 of the image forming apparatus 1 according to the present invention does not execute a warm-up operation by simply receiving print data.

The transmitting/receiving portion 111 controls processing for receiving the print data transmitted from the PC 2. In addition, the transmitting/receiving portion 111 functions as a message data transmitting portion which transmits message data generated by a message data generating portion 113a which will be described below to the PC 2, and as an allowed/not-allowed information receiving portion which receives allowed/not-allowed information from a user for the message data transmitted from the PC 2.

The print data recording portion 112 records the print data received by the transmitting/receiving portion 111.

The print processing control portion 113 has a timekeeping function and controls processing for printing the print data, at printing execution time included in the print data recorded in the print data recording portion 112.

The print processing control portion 113 further includes the message data generating portion 113a and a printing execution time specifying portion 113b.

When the transmitting/receiving portion 111 newly receives print data N transmitted from the PC 2, the message data generating portion 113a generates message data to inquire of the user X whether it is allowed to print the newly received print data N at the printing execution time included in the print data recorded in the print data recording portion 112.

The control portion 114 executes control processing of each function block.

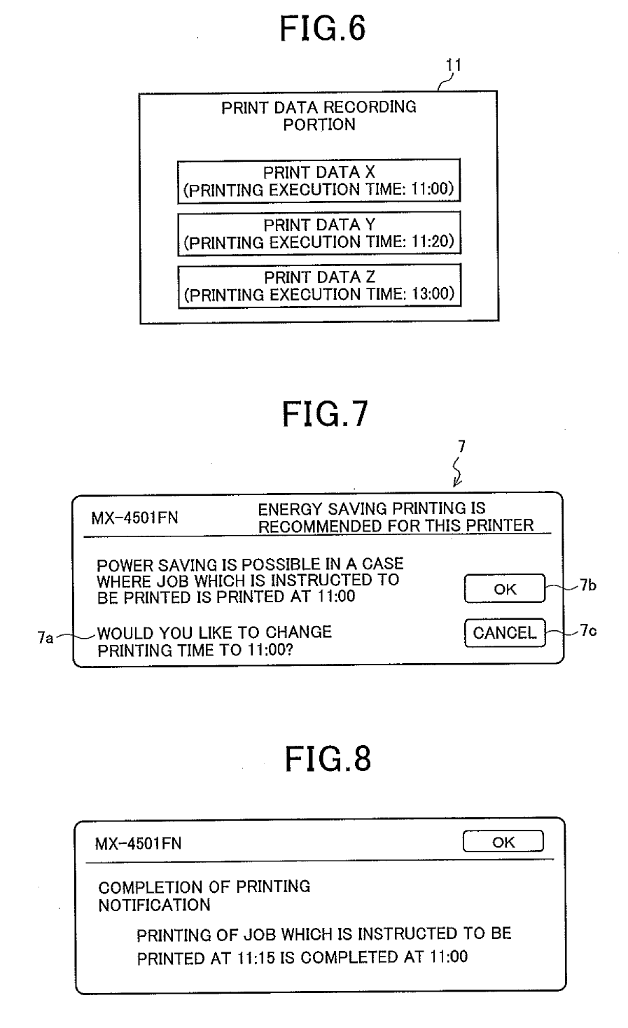

Description of a detail of generation processing of message data will be given here with use of FIG. 6.

FIG. 6 is a diagram schematically illustrating a state where a plurality of print data (X to Z) are recorded in the print data recording portion 112. Printing execution time included in the plurality of print data (X to Z) are “11:00”, “11:20”, and “13:00”. Note that, at these printing execution times, the print processing control portion 113 instructs the image forming portion 105 to print the print data, respectively.

As shown in FIG. 6, for example, in a state where the plurality of print data (X to Z) are recorded in the print data recording portion 112, the user X operates the PC 2 and instructs the image forming apparatus 1 to print the print data in which “11:15” is specified as printing execution time. Then, the printer driver 205b of the PC 2 generates print data N including the printing execution time (“11:15”) to transmit to the image forming apparatus 1.

The transmitting/receiving portion 111 of the image forming apparatus 1 receives the print data N including the printing execution time transmitted from the PC 2 to output to the print data recording portion 112 and the print processing control portion 113.

The printing execution time specifying portion 113b of the print processing control portion 113 specifies, from the printing execution times included in the plurality of print data (X to Z) which are recorded in the print data recording portion 112, at least one of the printing execution times whose time difference with the printing execution time included in the newly received print data N is equal to or less than a predetermined time, and further specifies, from the at least one of the printing execution times, a printing execution time which is just prior to the printing execution time included in the newly received print data N.

The longer the predetermined value is, the more print data are able to be recorded in the print data recording portion 112 and printed in a batch, thus making it possible to reduce power consumption, however, in view of a user who desires immediate printing of print data, it is preferable to set around between 30 minutes to 90 minutes. Note that, the predetermined value is stored in the memory 103.

Description of specific processing of printing execution time will hereinafter be given. Note that, it is assumed that the predetermined value is 30 minutes in the description below. The printing execution time specifying portion 113b, firstly calculates a time difference between the printing execution time included in the plurality of print data (X to Z) which are recorded in the print data recording portion 112 and the printing execution time included in the newly received print data N.

In the above-described example, the printing execution time included in the plurality of print data (X to Z) are “11:00”, “11:20”, and “13:00”, and the printing execution time included in the newly received print data N is “11:15”, therefore time differences are 15 minutes, 5 minutes, and 1 hour and 45 minutes, respectively.

Accordingly, the printing execution time specifying portion 113b specifies “11:00” (15 minutes time difference) and “11:20” (5 minutes time difference) as printing execution times whose time differences with the printing execution time included in the newly received print data N are equal to or less than a predetermined value (30 minutes).

Furthermore, the printing execution time specifying portion 113b specifies printing execution time which is just prior to the printing execution time included in the newly received print data from the specified printing execution times.

In the above-described example, the printing execution time specifying portion 113b specifies “11:00” which is printing execution time just prior to the printing execution time (“11:15”) included in the print data N from the specified printing execution times (“11:00” and “11:20”).

In addition, the printing execution time specifying portion 113b, when a plurality of print data including printing execution times are recorded in the print data recording portion 112, may specify, from the printing execution times, as described above, at least one of the printing execution times whose time difference with printing execution time included in the newly received print data N is equal to or less than a predetermined value, and further, may specify, from the at least one of the printing execution times, a printing execution time which is nearest to the printing execution time included in the newly received print data N.

In the above-described example, the printing execution time specifying portion 113b specifies “11:00” and “11:20” as printing execution times whose time differences with the printing execution time included in the newly received print data N are equal to or less than a predetermined value. In addition, the printing execution time included in the newly received print data N is “11:15”.

Accordingly, the printing execution time specifying portion 113b specifies “11:20” which is nearest printing execution time to the printing execution time (“11:15”) included in the newly received print data N from the specified printing execution times (“11:00” and “11:20”).

The following describes a case where the printing execution time specifying portion 113b specifies “11:00” for printing execution time as an example.

The message data generating portion 113a generates message data to inquire of the user X who instructed printing of the print data N whether it is allowed to print the newly received print data N at the printing execution time specified by the printing execution time specifying portion 113b.

In the above-described example, message data to inquire whether or not the newly received print data N may be printed at “11:00” is generated.

Note that, when printing execution time included in the print data N is “0”, that is, when a user desires to print the print data N immediately, the printing execution time specifying portion 113b specifies printing execution time which is nearest to current time from the printing execution time included in the plurality of print data (X to Z). Then, the message data generating portion 113a generates message data to inquire of the user X who instructed printing of the print data N whether it is allowed to print the newly received print data N at the specified printing execution time when a time difference between the printing execution time specified by the printing execution time specifying portion 113b and the current time is equal to or less than a predetermined value.

In addition, in the case where one print data including printing execution time is recorded in the print data recording portion 112, the message data generating portion 113a generates message data to inquire of a user whether it is allowed to print the newly received print data N at the printing execution time included in the one print data only when a time difference between the printing execution time included in the one print data and the printing execution time included in the newly received print data N is equal to or less than a predetermined value.

The inquiry message data created by the message data generating portion 113a is transmitted to the PC 2 by the transmitting/receiving portion 111.

Description of display processing of the inquiry message data which is transmitted to the PC 2 by the transmitting/receiving portion 111 of the image forming apparatus 1 will hereinafter be given.

When the transmitting/receiving portion 206 of the PC 2 receives the inquiry message data transmitted from the image forming apparatus 1, the inquiry message data is output to the printer driver 205b. The printer driver 205b generates inquiry message data for displaying from the inquiry message data to display on the liquid crystal display 5.

FIG. 7 is a diagram illustrating an inquiry message 7 which is displayed on the liquid crystal display 5.

In the inquiry message 7, “Would you like to change printing time to 11:00?” as denoted by a numeral 7a which is a message to inquire whether or not the print data N may be printed at “11:00” is displayed together with an OK button 7b and a cancel button 7c.

When the user X judges that the print data N may be (changed to be) printed at “11:00”, and then clicks the OK button 7b with the mouse 4, the printer driver 205b generates an allowed signal indicating to allow printing of the print data N to be executed at “11:00” as allowed/not-allowed information for the inquiry message to output to the transmitting/receiving portion 111. The transmitting/receiving portion 111 transmits the received allowed signal to the image forming apparatus 1.

On the other hand, when the user X does not judge that the print data N may be printed at “11:00”, and then clicks the cancel button 7c with the mouse 4, the printer driver 205b generates a not-allowed signal indicating not to allow printing of the print data N to be executed at “11:00” as allowed/not-allowed information for the inquiry message to output to the transmitting/receiving portion 111. The transmitting/receiving portion 111 transmits the received not-allowed signal to the image forming apparatus 1.

In the description below, an allowed signal and a not-allowed signal are collectively referred to as an allowed/not-allowed signal.

Description of processing executed in the image forming apparatus 1 which has received the allowed/not-allowed signal transmitted by the printer driver 205b of the PC 2 will hereinafter be given.

When the transmitting/receiving portion 111 of the image forming apparatus 1 receives the allowed/not-allowed signal transmitted from the PC 2, the allowed/not-allowed signal is output to the print processing control portion 113.

The print processing control portion 113, based on the received allowed/not-allowed signal (allowed/not-allowed information), determines printing execution time of the newly received print data N, and executes printing of the print data N at the determined time.

When the print processing control portion 113 receives an allowed signal, the printing execution time of the newly received print data N is changed (determined) to be printing execution time specified by the printing execution time specifying portion 113b. In the above-described example, the printing execution time of the print data N is determined to be “11:00”. The print processing control portion 113 records the print data N in the print data recording portion 112, and when coming to the determined printing execution time, instructs the image forming portion 105 to execute processing for printing the newly received print data N together with the print data X recorded in the print data recording portion 112.

After completion of printing, the message data generating portion 113a generates completion of printing message data (hereinafter referred to as completion of printing notification data) indicating that printing of the print data N is completed at the changed printing execution time to transmit to the PC 2. The completion of printing notification data is displayed on the liquid crystal display 5 of the PC 2 as shown in FIG. 8.

On the other hand, when the print processing control portion 113 receives a not-allowed signal, printing execution time of the newly received print data N is determined to be the printing execution time included in the print data N, and executes processing for printing the print data N at the printing execution time. In the above-described example, the printing execution time of the print data N is determined to be “11:15”.

Note that, when printing execution time included in the print data N is “0” (immediate printing), the print processing control portion 113 prints the newly received print data N immediately after receiving the not-allowed signal.

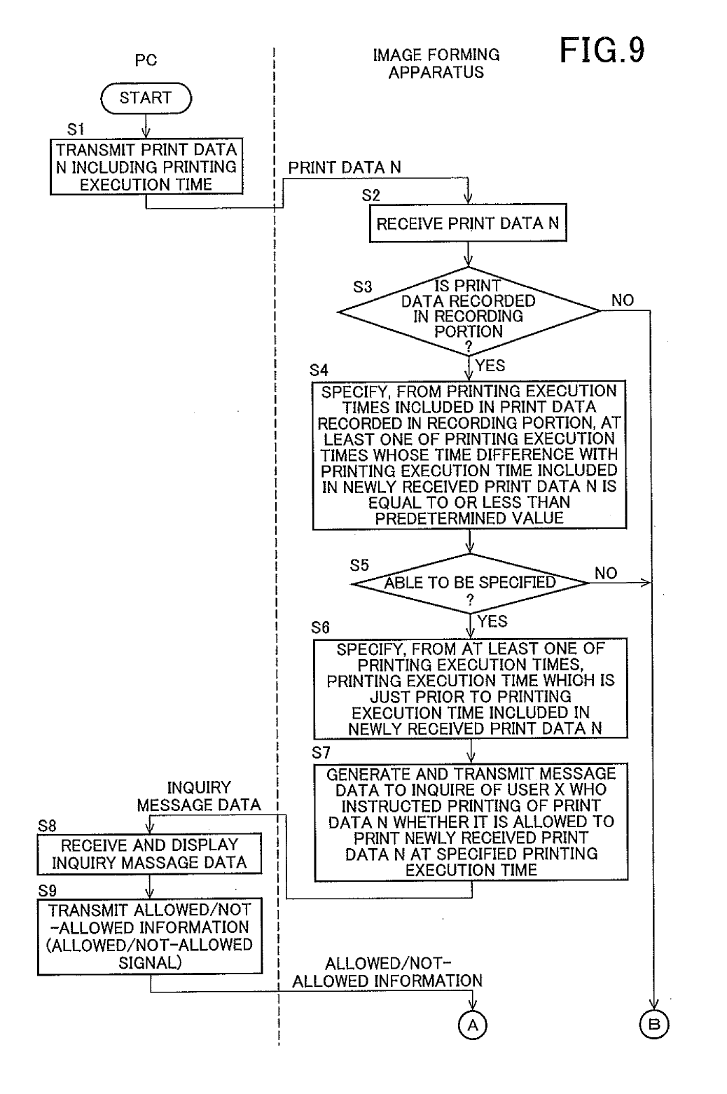

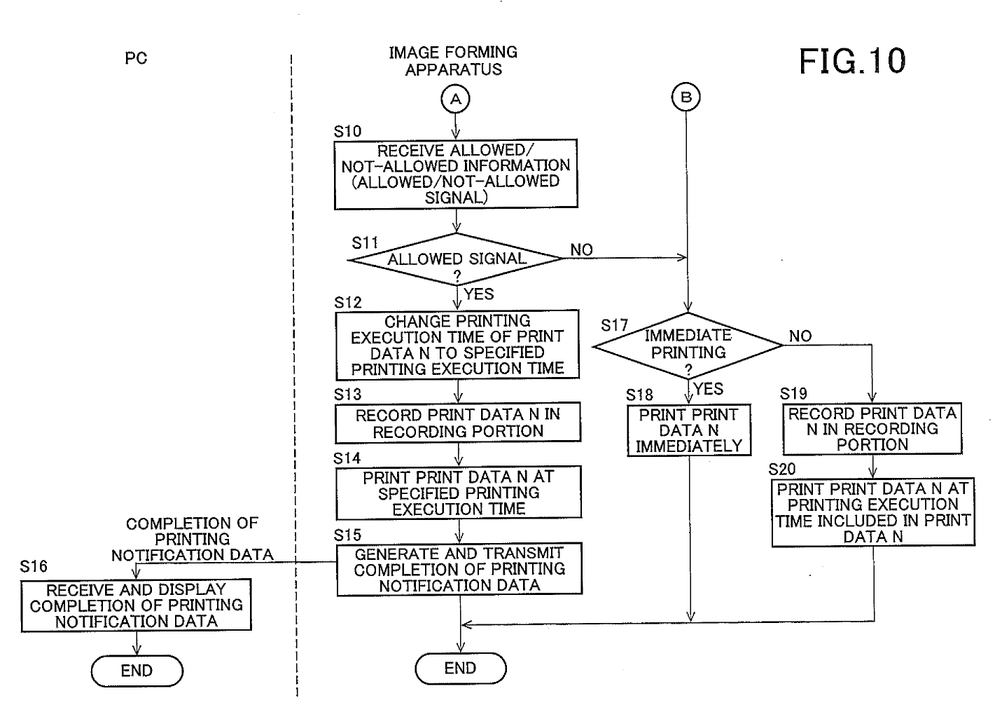

Next, description of a flow of generation processing of message data and print processing of print data executed in the image forming apparatus 1 will be given with use of flowcharts of FIG. 9 and FIG. 10.

As shown in FIG. 9, the user X operates the PC 2 and instructs the image forming apparatus 1 to print the print data whose printing execution time is specified. Then, the printer driver 205b of the PC 2 generates print data N including the printing execution time to transmit to the image forming apparatus 1 (step S1). Note that, when the user X desires to print the print data immediately without specifying printing execution time of the print data, “0” is set as printing execution time, for example.

The transmitting/receiving portion 111 of the image forming apparatus 1 receives the print data N including the printing execution time transmitted from the PC 2 (step S2), and the print processing control portion 113 judges whether or not print data including printing execution time is recorded in the print data recording portion 112 (step S3).

When the print data is recorded (step S3/YES), the printing execution time specifying portion 113b of the print processing control portion 113 specifies, from the printing execution times included in the print data recorded in the print data recording portion 112, at least one of the printing execution times whose time difference with the printing execution time included in the newly received print data N is equal to or less than a predetermined value (step S4).

When the specification is possible (step S5/YES), the printing execution time specifying portion 113b further specifies, from the at least one of the printing execution times, the printing execution time which is just prior to the printing execution time included in the newly received print data N (step S6). When there is no just-prior printing execution time, nearest printing execution time to the printing execution time included in the print data N is specified from the printing execution times specified at step S4.

Next, the message data generating portion 113a generates message data to inquire of the user X who instructed printing of the print data N whether it is allowed to print the newly received print data N at the printing execution time specified by the printing execution time specifying portion 113b, and the transmitting/receiving portion 111 transmits the inquiry message data to the PC 2 (step S7).

When the transmitting/receiving portion 206 of the PC 2 receives the inquiry message data transmitted from the image forming apparatus 1, the printer driver 205b generates inquiry message data for displaying from the received inquiry message data to display on the liquid crystal display 5 (step S8).

The printer driver 205b, based on an operation by the user X, generates allowed/not-allowed information (allowed/not-allowed signal) for the inquiry message to transmit to the image forming apparatus 1 (step S9).

When the transmitting/receiving portion 111 of the image forming apparatus 1 receives the allowed/not-allowed information (allowed/not-allowed signal) which is transmitted from the PC 2 (step S10), the print processing control portion 113 judges whether or not the allowed/not-allowed signal is an allowed signal (step S11).

When the allowed/not-allowed signal is an allowed signal (step S11/YES), the print processing control portion 113 changes printing execution time of the newly received print data N to the printing execution time specified by the printing execution time specifying portion 113b (step S12), and records the print data N in the print data recording portion 112 (step S13). Then, when coming to the specified printing execution time, printing of the print data N is executed (step S14).

Then, after completion of printing, the message data generating portion 113a generates completion of printing notification data indicating that printing of the print data N is completed at the specified printing execution time to transmit to the PC 2 (step S15).

The transmitting/receiving portion 206 of the PC 2 receives the completion of printing notification data, and the printer driver 205b displays the completion of printing notification data on the liquid crystal display 5 of the PC 2 (step S16).

When print data including the printing execution time is not recorded in the print data recording portion 112 (step S3/NO), when it is not possible to specify, from the printing execution times included in the print data recorded in the print data recording portion 112, at least one of the printing execution times whose time difference with the printing execution time included in the newly received print data N is equal to or less than a predetermined value (step S5/NO), or when the allowed/not-allowed signal is a not-allowed signal (step S11/NO), the printing control portion 114 judges whether or not the printing execution time included in the newly received print data N is “0”, that is, whether or not the user X specifies immediate printing with respect to the print data N (step S17).

When the print data N is for immediate printing (step S17/YES), the printing control portion 114 prints the print data N immediately (step S18).

When the print data N is not specified to be printed immediately (step S17/NO), the print processing control portion 113 records the print data N in the print data recording portion 112 (step S19). Then, when coming to the printing execution time included in the print data N, printing of the print data N is executed (step S20).

In this way, a user is able to select whether or not to execute shared printing, and therefore convenience for the user is improved. In addition, when the shared printing is executed, a plurality of print data are printed in a batch, thus making it possible to reduce the number of times of warm-up and save energy.

### Modification Example

It may be configured such that the predetermined value which is referred to when determining (changing) the printing execution time of the newly received print data N is able to be changed.

When making the change, the control portion 114 of the image forming apparatus 1 may be provided with a predetermined value setting portion which sets the predetermined value to be changeable.

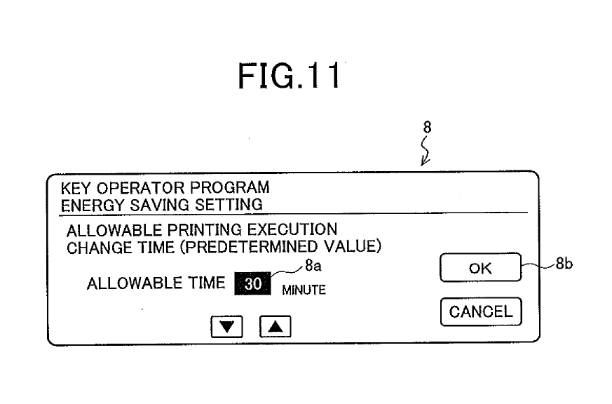

When the control portion 114 of the image forming apparatus 1 receives an operation to instruct the change of the predetermined value from a manager (also referred to as an administrator) of the image forming apparatus 1 through the operation panel 102, the predetermined value setting portion displays, for example, a predetermined value setting dialogue 8 which is shown in FIG. 11 on a display panel of the operation panel 102.

When the manager inputs a predetermined value in a predetermined value input box 8a of the predetermined value setting dialogue 8 and operates an OK button 8b, the predetermined value is stored in the memory 103 of the image forming apparatus 1.

Note that, the present invention may be applied to a multifunction peripheral (MFP) having a copy function, a facsimile transmitting/receiving function, a filing function, a function of preview display before printing, and the like, for example.

The printing execution time may be time to start print processing or time when print processing is finished.

According to the present invention, in an image forming apparatus which receives print data including printing execution time transmitted from an external apparatus and prints the print data at the printing execution time, a user is able to select whether or not to execute shared printing, and therefore convenience for the user is improved and it is possible to save energy.

1. An image forming apparatus which receives print data including printing execution time transmitted from an external apparatus and prints the print data at the printing execution time, comprising:
a recording portion which records print data including printing execution time transmitted from an external apparatus;
a message data generating portion which, when newly receiving print data including printing execution time transmitted from an external apparatus, generates message data to inquire of a user whether it is allowed to print the newly received print data at printing execution time included in the print data recorded in the printing portion;
a message data transmitting portion which transmits the message data generated by the message data generating portion to the external apparatus;
an allowed/not-allowed information receiving portion which receives allowed/not-allowed information transmitted from the external apparatus, the allowed/not-allowed information being related to user's answer to the massage data; and
a print processing control portion which determines printing execution time of the newly received print data based on the allowed/not-allowed information from the user received by the allowed/not-allowed information receiving portion.

2. The image forming apparatus as defined in claim 1, comprising
a printing execution time specifying portion that specifies, from the plurality of printing execution times, when a plurality of print data including printing execution time are recorded in the recording portion, at least one of the printing execution times whose time difference with a printing execution time included in the newly received print data is equal to or less than a predetermined value, and further specifies, from the at least one of the printing execution times, a printing execution time which is just prior to the printing execution time included in the newly received print data, and wherein
the message data generating portion generates message data to inquire of a user whether it is allowed to print the newly received print data at the just-prior printing execution time specified by the printing execution time specifying portion.

3. The image forming apparatus as defined in claim 1, comprising
a printing execution time specifying portion that specifies, from the plurality of printing execution times, when a plurality of print data including printing execution time are recorded in the recording portion, at least one of the printing execution times whose time difference with a printing execution time included in the newly received print data is equal to or less than a predetermined value, and further specifies, from the at least one of the printing execution times, a printing execution time which is nearest to the printing execution time included in the newly received print data, and wherein
the message data generating portion generates message data to inquire of a user whether it is allowed to print the newly received print data at the nearest printing execution time specified by the printing execution time specifying portion.

4. The image forming apparatus as defined in claim 1, wherein,
the message data generating portion, when one print data including printing execution time is recorded in the recording portion, only in a case where a time difference between the printing execution time included in the one print data and the printing execution time included in the newly received print data is equal to or less than a predetermined value, generates message data to inquire of a user whether it is allowed to print the newly received print data at the printing execution time included in the one print data.

5. The image forming apparatus as defined in claim 1, wherein,
the message data generating portion, after printing of the newly received print data is completed, generates completion of printing message data indicating that printing of the print data is completed, and
the message data transmitting portion transmits the completion of printing message data generated by the message data generating portion to the external apparatus.

6. The image forming apparatus as defined in claim 2, wherein,
a setting portion which sets the predetermined value to be changeable is included.

7. The image forming apparatus as defined in claim 1, wherein,
a warm-up operation is not executed even though print data transmitted from the external apparatus is newly received.
